(19) United States
(12) Patent Application Publication
(10) Pub. No.: US 2004/0220871 A1
(43) Pub. Date: Nov. 4, 2004

(54) Treasury "when issued" auction futures contracts

(75) Inventor: Joseph F. Benning, Summit, NJ (US)

Correspondence Address: FOLEY & LARDNER, 321 NORTH CLARK STREET, SUITE 2800, CHICAGO, IL, 60610-4764, US

(73) Assignee: The Board of Trade of the City of Chicago

(21) Appl. No.: 10/429,058

(22) Filed: May 2, 2003

(51) Int. Cl. G06F 17/60

(52) U.S. Cl. 705/37

(57) ABSTRACT

A futures contract in accordance with the principals of the present invention comprises a way to hedge exposure in when issued securities as well as in the auction bidding process. The trading unit is the notional value of a yet-to-be issued Treasury note. The futures contract is quoted in yield terms, in basis points and fractions of basis points. The last trading day of the futures contract is the day a Treasury note is auctioned, at the same time as the auction takes place. The delivery standard is the auction yield result announced by the Federal Reserve Bank. The futures contract settles for cash.

### FIELD OF THE INVENTION

The present invention relates to Treasury contracts.

### BACKGROUND OF THE INVENTION

Auctions are an integral component of the trading and distribution of U.S. Government Securities. U.S. Treasury coupon trading in the 2-year and 5-year sectors is significantly greater during auction times. Generally, cash trading averages an extra $25 Billion plus per day during auction weeks. (See detailed calculation, set forth below). Both Treasury auctions and “when issued” (WI) trading are important price discovery mechanisms.

In recent years, the U.S. Treasury has materially altered trading practices for government securities in at least two ways. First, as a matter of policy, the U.S. Treasury has shortened the “WI” trading period by reducing the time elapsed between financing announcements and auctions. Second, the U.S. Treasury has changed auction bidding procedures.

On Sep. 3, 1992, the U.S. Treasury announced that it would conduct single-price auctions to sell 2-year and 5-year notes. Previously, Treasury coupon bearing securities were sold only using multiple price auctions. As a result of its successful experience with 2-year and 5-year notes, the U.S. Treasury now sells all coupon issues using the single price auction method. These issues are assigned an identification number by the Committee on Uniform Securities Identification Procedures (CUSIP). CUSIP is operated by Standard & Poor's, located at 55 Water Street, New York, N.Y. 10041 (“S&P”). A listing all of all coupon auctions from October 1998 through February 2003 is set forth in Appendix 1.

Single price auctions differ from multiple price auctions in one important aspect. In multiple price auctions, awards are made at successively lower prices (higher yields) until the designated sale amount has been exhausted. Bids accepted at the lowest price (highest yield) are pro-rated. In a single price auction, bids are ranked from highest to lowest. When the point is reached where (cumulatively) all bonds are spoken for, accepted bids are then filled at the highest accepted yield (lowest price).

For example, consider the outcome for the same set of bids under different auction rules:

TABLE 1
$10 Billion Hypothetical Treasury Auction Bids
under Different Rules

| Multiple Price Auction | | Single Price Auction | |
|---|---|---|---|
| Quantity Bid | Yield Bid | Quantity Bid | Yield Bid |
| $2 Billion | 2.00% | $2 Billion | 2.00% |
| $3 Billion | 2.01% | $3 Billion | 2.01% |
| $5 Billion | 2.02% | $5 Billion | 2.02% |
| $6 Billion | 2.03% | $6 Billion (Not | 2.03% |
| | (Not accepted) | accepted) | |
| Total Bids | $16 Billion | Total Bids | $16 Billion |
| Total Awards | $10 Billion | Total Awards | $10 Billion |
| Average Yield | 2.013% | Auction Yield | 2.02% |

As Table 1 illustrates, under a multiple price auction the U.S. Treasury accepts the first $10 Billion worth of bids (in yield ascending order) at the yields bid for. In this example, an average weighted interest cost of 2.013% results. In a single price auction, the U.S. Treasury accepts the $10 Billion lowest yielding bids and awards all the bonds at the highest winning yield, which in this case is 2.02%.

Some economists, most prominently Milton Friedman (See Milton Friedman, Testimony in Employment, Growth, and Price Levels: Hearings before the Joint Economic Committee, 86^{th} Congress, 1^{st} Session, 3023-3026 (Oct. 30, 1959); Milton Friedman, How to Sell Government Securities, WALL STREET JOURNAL, Aug. 28, 1991, at A8), have argued that compared to single price auctions, the multiple auction process is costly. In its essence, the argument is that auction bidders are likely to bid more aggressively—pay higher prices—at single price auctions rather than at multiple price auctions. There are two reasons for this.

First, there is the problem of the “winner's curse.” (For a discussion of the winner's curse, see PETER BERNSTEIN, AGAINST THE GODS, THE REMARKABLE STORY OF RISK, 244 (John Wiley & Sons 1996); Paul F. Malvey, Christine M. Archibald, Sean T. Flynn, Uniform-Price Auctions: Evaluation of the Treasury Experience, Office of Market Finance, U.S. Treasury (1995) In a multiple price auction, successful bidders pay the actual price they bid. Conversely, in a single price auction successful bidders pay only the lowest price (highest yield). Multiple price auction bidders thus inadvertently signal their willingness to pay higher than market prices. As a result, attempts to sell the bonds immediately thereafter in the secondary market are liable to result in losses.

Thus, winning auction bonds results in losing money—hence the winner's curse. Since dealers are rational players seeking to maximize profits, they take steps to avoid the winner's curse: they bid lower prices (higher yields) than they otherwise would have, thereby increasing the U.S. Treasury's cost of funds. To the extent that single price auctions eliminate the winner's curse, bidders should be willing to bid more aggressively, thereby reducing the U.S. Treasury's borrowing costs.

Second, single price auctions are strategically simpler than multiple price auctions. As a result, bidders' information seeking costs are reduced. Moreover, in a single price system, those with specialized knowledge (e.g., dealers) lose their competitive edge. Reducing the importance of specialized knowledge encourages participation by others who would otherwise be hesitant to bid. This results in broader and deeper auction participation. In theory, the combination of these two factors should increase demand and reduce the U.S. Treasury financing costs.

The graph set forth in FIG. 1 illustrates the theory, where:

S is a supply curve;

P₁ is a first price;

P₂ is a second price, where P₂>P₁;

D₁ is a first demand curve;

D₂ is a second demand curve, where D₂>D₁;

E₁ is a first equilibrium point; and

E₂ is a second equilibrium point.

Equilibrium point E₁ occurs at the intersection of D₁ and S resulting in Price P₁. Equilibrium point E₂ occurs at the intersection of D₂ and S resulting in Price P₂. With no change in supply and an increase in demand (from D₁ to D₂), prices rise (from P₁ to P₂) for the reasons discussed above. The saving to the U.S. Treasury is equal to the difference in price times the quantity sold, that is:

Interest Savings=Q*(P₂−P₁).

As a matter of public policy the U.S. Treasury seeks financing at the lowest possible interest cost. Accordingly, the U.S. Treasury studied its experimental use of single price auctions. To conduct the study the U.S. Treasury used a quasi-experimental design. Results of single and multiple price auctions were compared. Specifically, single price auctions of 2-year and 5-year notes from September 1992 through December 1994 were compared with same maturity multiple price auctions from January 1990 through August 1992. (See Malvey, Archibald & Flynn).

The U.S. Treasury estimated the impact of using a single price format on U.S. Treasury interest costs and the distribution of participation in auctions. The U.S. Treasury reported the following findings. Initially, the concentration of auction awards to top dealers was reduced, implying broader participation. At the same time, shares awarded to large customers increased, further evidencing broadened participation. Between 1995 and 1998 the U.S. Treasury reported that the trend abated somewhat as dealers gained experience with the single price format.

The U.S. Treasury also found some evidence that under the multiple price format, dealers were able to command a yield premium. However, under a single price format, there was no statistically significant evidence that that dealers could command this premium. The U.S. Treasury interpreted this to mean that single price auctions resulted in more aggressive bidding leading to reduced financing costs. Thus, single price auctions are here to stay.

Once the U.S. Treasury schedules an auction of Treasury securities, cash dealers begin to trade the new issue on a WI basis. In the WI market, dealers quote the securities on a yield basis to be settled by an exchange of cash for securities. The WI settlement date for the securities to be sold at auction is announced by the U.S. Treasury. The dollar price for settlement purposes is determined by conventional yield-to-price calculations once the security's coupon has been established through the auction process.

There is a well-developed WI market. However, as previously noted the U.S. Treasury has been narrowing the time frame between auction announcements and the actual auction date. As a result, WI periods have been greatly shortened over time, reducing the time dealers have to distribute the new securities. Typically, the WI period for 2-year notes is a few days.

Changing the auction format to single price while shortening the WI period greatly reduces dealers' information advantages and exposes them to greater risk. Not only does the short WI period make it more difficult for dealers to gauge market demand, the single price auction format exposes dealers to the possibility of aggressive bidding that may come “through the market”, forcing them to pay premium prices to cover prior sales. Bidding “through the market” refers to the practice of offering to buy at a price that is higher than the one nominally offered in order to gain a strategic advantage. In the Treasury market there are quantity restrictions placed on bidders so that any one bidder (or group acting in concert) may not buy all the auction supply. Nevertheless, dealers often bid higher than the nominal offered price and for greater size than they actually wish to buy in order to attain a better position in the queue when the bids are tallied.

Dealers may choose whether to participate (or the likelihood of participation) in a given auction by calibrating the aggressiveness of their bidding. To make sure they buy securities at an auction, dealers may be tempted to “bid through” the market to be assured of purchasing the required supply; at the same time they hope that their competitors do not adopt the same strategy, which would have the effect of lowering auction yields below existing yields in the secondary market.

However, recent history shows that auctions have not been overly kind to dealers. It is not unusual for auctions to be priced at a premium, rather than a discount, to the cash WI market. The U.S. Treasury found that in 70 out of 138 auctions conducted between September 1992 and May 1998, auctions were priced more expensively than 1:00 PM WI bid side yields, producing negative yield spreads for participating dealers. (See Uniform-Price Auctions: Update of the U.S. Treasury Experience, available at http://www.ustreas.gov/offices/domestic-finance/debt-management/auctions-study/final.pdf 14 (1998)). There exists no instrument for dealers to hedge themselves against this in the auction process. Moreover, such premium bids may be discrete events lacking secondary market follow through, leaving participants with instantaneous losses. (See Malvey, Archibald and Flynn (discussing strategic bidding at auctions)).

What would therefore be desirable would be a contract that captures the price behavior of the underlying “to be issued” security when it is available for trading in the cash market. Such contract could also serve as a substitute WI security before the cash security is available in the cash market. Such contract could provide a hedge against auction uncertainty and promote transparency in auction pricing.

### SUMMARY OF THE INVENTION

A futures contract in accordance with the principals of the present invention captures the price behavior of the underlying “to be issued” security when it is available for trading in the cash market. A futures contract in accordance with the principals of the present invention serves as a substitute WI security before the cash security is available in the cash market. A futures contract in accordance with the principals of the present invention provides a hedge against auction uncertainty and promotes transparency in auction pricing.

A futures contract in accordance with the principals of the present invention comprises a way to hedge exposure in when issued securities as well as in the auction bidding process. The trading unit is the notional value of a yet-to-be issued Treasury note. The futures contract is quoted in yield terms, in basis points and fractions of basis points. The last trading day of the futures contract is the day a Treasury note is auctioned, at the same time as the auction takes place. The delivery standard is the auction yield result announced by the Federal Reserve Bank. The futures contract settles for cash.

### BRIEF DESCRIPTION OF THE DRAWINGS

FIG. 1 is a graph illustrating that the shortening of the trading period and the changed auction bidding procedures increase demand and reduce the U.S. Treasury financing costs.

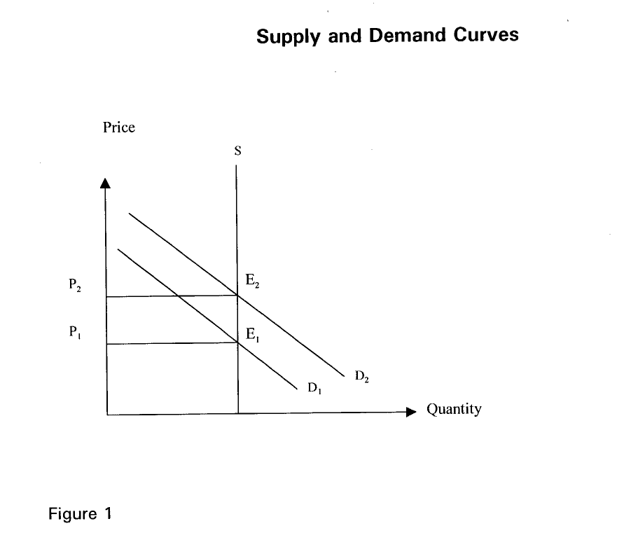

FIG. 2 a graph illustrating the relationship between market levels and the dollar value of 1 basis point for 2-year notes.

### DETAILED DESCRIPTION OF THE INVENTION

A futures contract in accordance with the principals of the present invention provides a way for dealers (and other auction participants) to hedge exposure in WI securities as well as the auction bidding process. A futures contract in accordance with the principals of the present invention creates a futures market in the U.S. Treasury WI securities that settle for cash at the auction yield. A futures contract in accordance with the principals of the present invention allows for a longer de facto WI period with centralized clearing and margining. A futures contract in accordance with the principals of the present invention also allows market participants to take either side of the market with respect to auction pricing.

Currently, only the U.S. Treasury can sell at the average auction price. Consequently, auction participants are held hostage to overly aggressive bids. A futures contract in accordance with the principals of the present invention allows hedgers and speculators to manage exposure to the uncertainty of the auction process. If they anticipate that an auction will “come rich” they can buy WI futures contracts; if they think the auction will “come cheap” they can sell WI contracts short. By carrying positions through the auction bidding process, market participants can potentially capture spreads that develop between cash WI markets and auction results. This is in addition to using correlated price behavior between cash and futures of equal duration to hedge secondary market positions. Because contracts in accordance with the present invention settle for cash using the auction results as a reference rate, the settlement price is an unambiguously transparent, accurate and efficient measure of the market.

The U.S. Treasury auctions, the manner in which the U.S. Treasury sells almost all its publicly held debt, are an integral part of trading in the government securities market. An examination of cash trading volume in various Treasury maturities during auction weeks makes this clear. The Federal Reserve (Fed) publishes trading volume in government securities in its weekly report of Primary Dealer Transactions in Government Securities. (See Weekly Transactions, available at http://www.ny.frb.org/pihome/statistics/dealer.shtml) In it, the Fed reports average daily trading volume by government securities dealers and their customers (with a 2-week time lag). Because virtually all secondary-market transactions in government securities are executed through dealers, these data are an accurate representation of the universe of transactions in the marketplace.

These data can be used to estimate the impact of auctions on trading, and hence the importance of auctions to the market. A simple auction impact model is:

Y=α+β₁X₁+ε,

where

Y is the cash trading volume;

X₁ is the dichotomous variable denoting an auction week (Yes is 1; No is 0);

β is the impact estimator;

α is the intercept; and

ε is the error term.

Utilizing this equation for the period extending from Nov. 21, 2001, through Mar. 19, 2003, for both 2-year and 5-year notes produces statistically significant (p=0.01) results. On average, during their respective auction weeks, cash trading in the 2-year note sector increases by about $25 Billion per day, while average daily trading in the 5-year sector increases by about $29 Billion. (Detailed regression results are included in Appendix 2) No outstanding futures contracts fully capture increased trading due to impending auctions. Nor do any outstanding futures contracts (or cash securities) capture the pricing impact of the single price auctions used to sell these securities.

A futures contract in accordance with the principals of the present invention is modeled on, and settles against, the cash Treasury auction. The trading unit is the notional value of a yet-to-be issued Treasury note. The delivery standard is the auction yield result announced by the Federal Reserve Bank. The contract is cash settled.

While an exemplary contract in accordance with the principals of the present invention is described below, it should be appreciated that the use of different elements and different combinations thereof are to be considered within the scope of the present invention

### EXAMPLE

An example of a futures contract in accordance with the principals of the present invention is a 2-year note futures contract having a notional value of $1,000,000. The contract will be quoted in yield terms rather than price terms. This mirrors conventional cash market practice. In general, a Treasury security's coupon rate is determined at an auction. Consequently, before an auction takes place, WI securities can only be quoted in yield (because the coupon is required for a meaningful price quote).

Yield quotes will be in basis points and fractions of basis points. (One hundred basis points equal one full percentage point or 1%). The minimum increment or “tick” size will be ¼ of one full basis point. The dollar value of one basis point for the contract will equal $185.83. One-quarter of one basis point will equal $46.46. Using $185.83 as the dollar value of 1 basis point implicitly centers the contract at a 6% market rate, consistent with existing 2-year, 5-year, 10-year and bond contracts that trade on a price and cash delivery basis at the Board of Trade of the City of Chicago, 141 West Jackson Boulevard, Chicago, Ill. 60604-2994 (CBOT). Ticks may extend to 4 decimal places—for example, 1.7125 bid/1.7075 offered.

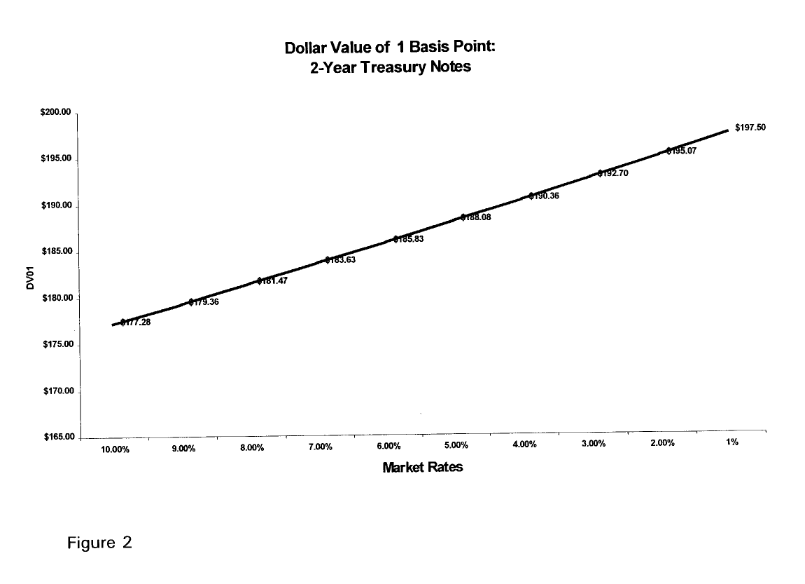

The dollar value of 1 basis point is not static in the market place; it is sensitive to the level of rates. (See FRANK J. FABOZZI, FIXED INCOME MATHEMATICS, chap. 5-7 (McGraw-Hill 3rd ed. 1997)). Consequently, hedge ratios may have to be re-weighted, depending on the level of rates. FIG. 2 shows a graph illustrating the relationship between market levels and the dollar value of 1 basis point for 2-year notes.

Twelve consecutive calendar months will be available for listing. Those months included in the U.S. Treasury's Tentative Schedule of Issues to be Announced and Auctioned will be listed for trading. (The current schedule includes 6 months: February through July 2003). The Treasury's Office of Market Finance publishes the schedule on its website. (See http://www.ustreas.gov/offices/domestic-finance/debtmanagement/auctions/index.html) The designated front month contract is the one that will be settled against the next 2-year note auction.

The last trading day for the front contract is the day of the auction. The last trading day will be the day a two-year Treasury note is auctioned, at the same time as the auction takes place. Trading will cease at the time auction bids are due at the Fed. That time is designated by the New York Federal Reserve Bank, 33 Liberty Street, New York, N.Y. 10045, and is usually (almost, but not always) at 1:00 PM Eastern time. For example if the Treasury auction takes place at 1:00 PM EST January 29, futures trading stops at 1:00 PM EST January 29. The contract will be cash settled against the auction yield announced by the Federal Reserve.

In the event that the Treasury cancels an announced and scheduled auction, the constant maturity 2-year rate published by the Federal Reserve for the scheduled auction day shall serve as the settlement reference rate. In the event the Treasury postpones an auction within the delivery month, the last trading day will remain the actual auction day and the settlement price will remain the auction price. In the event the Treasury postpones an auction so that it falls outside the current (spot) delivery month but does not supplant another scheduled auction, the last trading day will remain the actual auction day and the auction results will remain the settlement reference rate. For example, if the Treasury has already scheduled March 30 and April 28 auctions and the March 30 auction is postponed until April 1—e.g. because of weather or debt ceiling problems—the April 1 auction results would serve as the reference rate for settling the March contract.

While the invention has been described with specific embodiments, other alternatives, modifications and variations will be apparent to those skilled in the art. For example, a futures contract in accordance with the principals of the present invention can be based on a 2-year note, 5-year note, or any appropriate note term. All such alternatives, modifications and variations are intended to be included within the spirit and scope of the appended claims.

APPENDIX 1
Coupon Auctions and their Sizes
from Oct 1998 through Feb 2003
Jan.-Feb. 2003

| CUSIP | 912828AV2 | 912828AT7 | 912828AU4 | 912828AS9 | 912828AF7 |
|---|---|---|---|---|---|
| Security Description | 2-YR | 5-YR | 10-YR | 2-YR | 9-YR 6-MTH |
| Announce Date | 2/24/03 | 2/5/03 | 2/5/03 | 1/27/03 | 1/6/03 |
| Auction Date | 2/26/03 | 2/11/03 | 2/12/03 | 1/29/03 | 1/8/03 |
| Issue Date | 2/28/03 | 2/18/03 | 2/18/03 | 1/31/03 | 1/15/03 |
| Maturity Date | 2/28/05 | 2/15/08 | 2/15/13 | 1/31/05 | 7/15/12 |
| Offering Amount | 27 | 24 | 18 | 27 | 6 |
| Total Amount Tendered | 62214019 | 37646433 | 34758222 | 46750432 | 13300452 |
| Total Amount Accepted | 35332941 | 27483982 | 19496544 | 33834307 | 6000109 |
| Low Yield | 1.5 | 2.9 | 3.9 | 1.6 | 2.2 |
| Price at Low Yield | N/A | N/A | N/A | N/A | N/A |
| Avg/Med Yield | 1.54 | 2.98 | 3.93 | 1.67 | 2.3 |
| Price at Avg/Med Yield | N/A | N/A | N/A | N/A | N/A |
| High Yield | 1.58 | 3.03 | 3.96 | 1.71 | 2.34 |
| Price at High Yield | 99.9 | 99.9 | 99.3 | 99.8 | 106 |
| Allocation % at High Rate | 90.26 | 71.96 | 51.28 | 65.21 | N/A |
| Original Issue Date | N/A | N/A | N/A | N/A | 07/15/02 |
| Interest Rate | 1.5 | 3 | 3.875 | 1.625 | 3 |
| 1st Int. Payment Date | 8/31/03 | 8/15/03 | 8/15/03 | 7/31/03 | 7/15/03 |
| Series | H-2005 | E-2008 | A-2013 | G-2005 | C-2012 |
| Standard Interest Payment | 7.5 | 15 | 19.375 | 8.125 | N/A |

July-Dec. 2002

| CUSIP | 912828AR1 | 912828AQ3 | 912828AN0 | 912828AP5 | 912828AM2 | 912828AF7 | 912828AL4 | 912828AK6 | 912828AJ9 | 912828AH3 | 912828AG5 | 912828AF7 |
|---|---|---|---|---|---|---|---|---|---|---|---|---|
| Security | 2 YR | 2 YR | 5 YR | 10 YR | 2 YR | 9 YR | 2 YR | 2 YR | 10 YR | 5 YR | 2 YR | 10 YR |
| Description | | | | | | 9 MTH | | | | | | |
| Announce | 12/19/02 | 11/25/02 | 10/30/02 | 10/30/02 | 10/21/02 | 10/7/02 | 9/23/02 | 8/26/02 | 7/31/02 | 7/31/02 | 7/17/02 | 7/8/02 |
| Date | | | | | | | | | | | | |
| Auction Date | 12/23/02 | 11/27/02 | 11/5/02 | 11/6/02 | 10/23/02 | 10/9/02 | 9/25/02 | 8/28/02 | 8/7/02 | 8/6/02 | 7/24/02 | 7/10/02 |
| Issue Date | 12/31/02 | 12/2/02 | 11/15/02 | 11/15/02 | 10/31/02 | 10/15/02 | 9/30/02 | 9/3/02 | 8/15/02 | 8/15/02 | 7/31/02 | 7/15/02 |
| Maturity Date | 12/31/04 | 11/30/04 | 11/15/07 | 11/15/12 | 10/31/04 | 7/15/12 | 9/30/04 | 8/31/04 | 8/15/12 | 8/15/07 | 7/31/04 | 7/15/12 |
| Offering | 27 | 27 | 22 | 18 | 27 | 7 | 27 | 27 | 18 | 22 | 27 | 9 |
| Amount | | | | | | | | | | | | |
| Total Amount | 57198116 | 53660076 | 44424214 | 34292640 | 51167042 | 9493687 | 61698835 | 68429927 | 24852355 | 42148271 | 48414434 | 22870705 |
| Tendered | | | | | | | | | | | | |
| Total Amount | 33195093 | 32863976 | 23308184 | 18110960 | 32434883 | 7000047 | 34652350 | 34536730 | 19644624 | 25395876 | 33236962 | 10010395 |
| Accepted | | | | | | | | | | | | |
| Low Yield | 1.8 | 2 | 2.9 | 4 | 2.1 | 2.1 | 1.9 | 2.2 | 4.3 | 3.2 | 2.1 | 3 |
| Price at Low | N/A | N/A | N/A | N/A | N/A | N/A | N/A | N/A | N/A | N/A | N/A | N/A |
| Yield | | | | | | | | | | | | |
| Avg/Med Yield | 1.79 | 2.08 | 2.99 | 4.07 | 2.1 | 2.15 | 1.91 | 2.2 | 4.3 | 3.32 | 2.22 | 3.05 |
| Price at | N/A | N/A | N/A | N/A | N/A | N/A | N/A | N/A | N/A | N/A | N/A | N/A |
| Avg/Med Yield | | | | | | | | | | | | |
| High Yield | 1.82 | 2.12 | 3.03 | 4.1 | 2.14 | 2.26 | 1.96 | 2.22 | 4.39 | 3.35 | 2.27 | 3.1 |
| Price at High | 99.9 | 99.8 | 99.9 | 99.2 | 100 | 107 | 99.8 | 99.8 | 99.9 | 99.6 | 100 | 99.2 |
| Yield | | | | | | | | | | | | |
| Allocation % | 60.06 | 53.79 | 56.3 | 86.41 | 42.29 | 72.92 | 70.43 | 6.14 | 49.47 | 82.67 | 11.1 | 81.62 |
| at High Rate | | | | | | | | | | | | |
| Original Issue | N/A | N/A | N/A | N/A | 10/31/02 | 07/15/02 | 09/30/02 | N/A | N/A | N/A | N/A | N/A |
| Date | | | | | | | | | | | | |
| Interest Rate | 1.75 | 2 | 3 | 4 | 2.125 | 3 | 1.875 | 2.125 | 4.375 | 3.25 | 2.25 | 3 |
| 1st Int. | 6/30/03 | 5/31/03 | 5/15/03 | 5/15/03 | 4/30/03 | 1/15/03 | 3/31/03 | 2/28/03 | 2/15/03 | 2/15/03 | 1/31/03 | 1/15/03 |
| Payment Date | | | | | | | | | | | | |
| Series | V-2004 | U-2004 | G-2007 | E-2012 | T-2004 | C-2012 | S-2004 | R-2004 | D-2012 | F-2007 | Q-2004 | C-2012 |
| Standard | 8.75 | 10 | 15 | 20 | 10.625 | N/A | 9.375 | 10.625 | 21.875 | 16.25 | 11.25 | N/A |
| Interest | | | | | | | | | | | | |
| Payment | | | | | | | | | | | | |

Jan.-June 2002

| CUSIP | 912828AE0 | 912828AD2 | 912828AC4 | 9128277L0 | 912828AB6 | 912828AA8 | 9128277M8 | 9128277F3 | 9128277L0 | 9128277K2 | 9128277J5 |
|---|---|---|---|---|---|---|---|---|---|---|---|
| Security | 2 YR | 2-YR | 5-YR | 9-YR 9- MTH | 2-YR | 2-YR | 2-YR | 4-YR 9- MTH | 10-YR | 2-YR | 10-YR |
| Description | | | | | | | | | | | |
| Announce | 6/28/02 | 5/22/02 | 5/1/02 | 5/1/02 | 4/17/02 | 3/20/02 | 2/20/02 | 1/30/02 | 1/30/02 | 1/16/02 | 1/2/02 |
| Date | | | | | | | | | | | |
| Auction Date | 6/28/02 | 5/29/02 | 5/7/02 | 5/8/02 | 4/24/02 | 3/27/02 | 2/27/02 | 2/5/02 | 2/6/02 | 1/23/02 | 1/9/02 |
| Issue Date | 7/1/02 | 5/31/02 | 5/15/02 | 5/15/02 | 4/30/02 | 4/1/02 | 2/28/02 | 2/15/02 | 2/15/02 | 1/31/02 | 1/15/02 |
| Maturity | 6/30/04 | 5/31/04 | 5/15/07 | 2/15/12 | 4/30/04 | 3/31/04 | 2/29/04 | 11/15/06 | 2/15/12 | 1/31/04 | 1/15/12 |
| Date | | | | | | | | | | | |
| Offering | 27 | 27 | 22 | 11 | 25 | 25 | 25 | 16 | 13 | 25 | 6 |
| Amount | | | | | | | | | | | |
| Total Amount | 42484491 | 78799558 | 40155236 | 24073072 | 57596062 | 56915536 | 51952645 | 24400851 | 24105680 | 44245498 | 14317397 |
| Tendered | | | | | | | | | | | |
| Total Amount | 34046543 | 33298408 | 24340976 | 11391634 | 32648157 | 32873496 | 31734810 | 16944334 | 13752839 | 30766423 | 6000004 |
| Accepted | | | | | | | | | | | |
| Low Yield | 2.8 | 3.2 | 4.4 | 5.1 | 3.3 | 3.6 | 3 | 4.2 | 4.8 | 2.9 | 3.4 |
| Price at Low | N/A | N/A | N/A | N/A | N/A | N/A | N/A | N/A | N/A | 99.9 | 0 |
| Yield | | | | | | | | | | | |
| Avg/Med | 2.9 | 3.26 | 4.43 | 5.15 | 3.35 | 3.67 | 3.01 | 4.21 | 4.84 | 2.98 | 3.45 |
| Yield | | | | | | | | | | | |
| Price at | N/A | N/A | N/A | N/A | N/A | N/A | N/A | N/A | N/A | 99.9 | N/A |
| Avg/Med | | | | | | | | | | | |
| Yield | | | | | | | | | | | |
| High Yield | 2.97 | 3.27 | 4.48 | 5.17 | 3.38 | 3.71 | 3.06 | 4.25 | 4.88 | 3.04 | 3.48 |
| Price at High | 99.8 | 100 | 99.6 | 97.7 | 100 | 99.8 | 99.9 | 96.8 | 100 | 99.9 | 99.1 |
| Yield | | | | | | | | | | | |
| Allocation % | 69.04 | 6.82 | 71.82 | 74.52 | 53.87 | 95.37 | 35.07 | 11.31 | 31.06 | 58.9 | 91.98 |
| at High Rate | | | | | | | | | | | |
| Original Issue | N/A | N/A | N/A | 02/15/02 | 04/30/02 | N/A | N/A | 11/15/01 | 02/15/02 | N/A | 01/15/02 |
| Date | | | | | | | | | | | |
| Interest Rate | 2.875 | 3.25 | 4.375 | 4.875 | 3.375 | 3.625 | 3 | 3.5 | 4.875 | 3 | 3.375 |
| 1st Int. | 12/31/02 | 11/30/02 | 11/15/02 | 8/15/02 | 10/31/02 | 9/30/02 | 8/31/02 | 5/15/02 | 8/15/02 | 7/31/02 | 7/15/02 |
| Payment | | | | | | | | | | | |
| Date | | | | | | | | | | | |
| Series | P-2004 | N-2004 | E-2007 | B-2012 | M-2004 | L-2004 | K-2004 | F-2006 | B-2012 | J-2004 | A-2012 |
| Standard | 14.375 | 16.25 | 21.875 | 24.375 | 16.875 | 18.125 | 15 | 17.5 | 24.375 | 15 | N/A |
| Interest | | | | | | | | | | | |
| Payment | | | | | | | | | | | |

July-Dec. 2001

| CUSIP | 9128277H9 | 9128277G1 | 9128277F3 | 9128277B2 | 9128277E5 | 9128277B2 | 9128277D8 | 9128277C0 | 9128276X5 | 9128277B2 | 9128277A4 | 9128276R8 |
|---|---|---|---|---|---|---|---|---|---|---|---|---|
| Security Description | 2-YR | 2-YR | 5-YR | 9-YR 9-MTH | 2-YR | 9-YR 10- MTH | 2-YR | 2-YR | 4-YR 9- MTH | 10-YR | 2-YR | 9-YR 6- MTH |
| Announce Date | 12/19/01 | 11/21/01 | 10/31/01 | 10/31/01 | 10/17/01 | 10/4/01 | 9/19/01 | 8/22/01 | 8/1/01 | 8/1/01 | 7/18/01 | 7/5/01 |
| Auction Date | 12/27/01 | 11/28/01 | 11/6/01 | 11/7/01 | 10/24/01 | 10/4/01 | 9/26/01 | 8/29/01 | 8/7/01 | 8/8/01 | 7/25/01 | 7/11/01 |
| Issue Date | 12/31/01 | 11/30/01 | 11/15/01 | 11/15/01 | 10/31/01 | 10/5/01 | 10/1/01 | 8/31/01 | 8/15/01 | 8/15/01 | 7/31/01 | 7/16/01 |
| Maturity Date | 12/31/03 | 11/30/03 | 11/15/06 | 8/15/11 | 10/31/03 | 8/15/11 | 9/30/03 | 8/31/03 | 5/15/06 | 8/15/11 | 7/31/03 | 1/15/11 |
| Offering | 23 | 21 | 16 | 7 | 19 | 6 | 17 | 14 | 11 | 11 | 12 | 5 |
| Amount | | | | | | | | | | | | |
| Total Amount | 61962836 | 36928640 | 37671036 | 15635662 | 49362755 | 14175225 | 46848079 | 34980539 | 24249419 | 32395067 | 33505862 | 9505498 |
| Tendered | | | | | | | | | | | | |
| Total Amount | 29666268 | 26167440 | 18799456 | 8591710 | 25142691 | 6000038 | 22666754 | 18666698 | 11623510 | 12043085 | 16000048 | 5000004 |
| Accepted | | | | | | | | | | | | |
| Low Yield | 3.2 | 2.9 | 3.55 | 4.135 | 2.7 | 4.4 | 2.79 | 3.62 | 4.6 | 5.03 | 3.9 | 3.43 |
| Price at Low | N/A | N/A | N/A | N/A | 0 | 0 | N/A | N/A | N/A | N/A | N/A | N/A |
| Yield | | | | | | | | | | | | |
| Avg/Med Yield | 3.28 | 2.96 | 3.58 | 4.188 | 2.74 | 4.499 | 2.82 | 3.65 | 4.651 | 5.07 | 3.94 | 3.468 |
| Price at | N/A | N/A | N/A | N/A | N/A | N/A | N/A | N/A | N/A | N/A | N/A | N/A |
| Avg/Med Yield | | | | | | | | | | | | |
| High Yield | 3.3 | 3.01 | 3.62 | 4.22 | 2.77 | 4.52 | 2.87 | 3.69 | 4.67 | 5.08 | 3.97 | 3.5 |
| Price at High | 99.9 | 100 | 99.5 | 106 | 100 | 104 | 99.8 | 99.9 | 99.8 | 99.4 | 99.8 | 102 |
| Yield | | | | | | | | | | | | |
| Allocation % | 27.52 | 14.96 | 93.14 | 83.52 | 86.62 | 53.57 | 49.03 | 31.45 | 95.66 | 63.72 | 45.37 | 86.09 |
| at High Rate | | | | | | | | | | | | |
| Original Issue | N/A | N/A | N/A | 08/15/01 | N/A | N/A | 08/15/01 | N/A | 05/15/01 | N/A | N/A | 01/16/01 |
| Date | | | | | | | | | | | | |
| Interest Rate | 3.25 | 3 | 3.5 | 5 | 2.75 | 5 | 2.75 | 3.625 | 4.625 | 5 | 3.875 | 3.5 |
| 1st Int. | 6/30/02 | 5/31/02 | 5/15/02 | 2/15/02 | 4/30/02 | 2/15/02 | 3/31/02 | 2/28/02 | 11/15/01 | 2/15/02 | 1/31/02 | 1/15/02 |
| Payment Date | | | | | | | | | | | | |
| Series | X-2003 | W-2003 | F-2006 | C-2011 | V-2003 | C-2011 | U-2003 | T-2003 | E-2006 | C-2011 | S-2003 | A-2011 |
| Standard | 16.25 | 15 | 17.5 | 25 | 13.75 | 25 | 13.75 | 18.125 | 23.125 | 25 | 19.375 | N/A |
| Interest | | | | | | | | | | | | |
| Payment | | | | | | | | | | | | |

Jan.-June 2001

| CUSIP | 9128276Z0 | 9128276Y3 | 9128276X5 | 9128276T4 | 9128276W7 | 9128276V9 | 9128276U1 | 9128276N7 | 9128276T4 | 9128276S6 | 9128276R8 |
|---|---|---|---|---|---|---|---|---|---|---|---|
| Security | 2-YR | 2-YR | 5-YR | 9-YR 9- MTH | 2-YR | 2-YR | 2-YR | 4-YR 9- MTH | 10-YR | 2-YR | 10-YR |
| Description | | | | | | | | | | | |
| Announce | 6/20/01 | 5/23/01 | 5/2/01 | 5/2/01 | 4/18/01 | 3/21/01 | 2/14/01 | 1/31/01 | 1/31/01 | 1/17/01 | 1/3/01 |
| Date | | | | | | | | | | | |
| Auction Date | 6/27/01 | 5/30/01 | 5/8/01 | 5/9/01 | 4/25/01 | 3/28/01 | 2/21/01 | 2/6/01 | 2/7/01 | 1/24/01 | 1/10/01 |
| Issue Date | 7/2/01 | 5/31/01 | 5/15/01 | 5/15/01 | 4/30/01 | 4/2/01 | 2/28/01 | 2/15/01 | 2/15/01 | 1/31/01 | 1/16/01 |
| Maturity Date | 6/30/03 | 5/31/03 | 5/15/06 | 2/15/11 | 4/30/03 | 3/31/03 | 2/28/03 | 11/15/05 | 2/15/11 | 1/31/03 | 1/15/11 |
| Offering | 11 | 10 | 13 | 9 | 10 | 11 | 11 | 11 | 11 | 10 | 6 |
| Amount | | | | | | | | | | | |
| Total Amount | 28559898 | 29215422 | 29541090 | 25481724 | 30200534 | 34376577 | 29901323 | 23235682 | 24031491 | 31791612 | 10110181 |
| Tendered | | | | | | | | | | | |
| Total Amount | 14666746 | 13333342 | 16174918 | 11457320 | 13335524 | 14673572 | 14675223 | 12278682 | 11974691 | 15437052 | 6000430 |
| Accepted | | | | | | | | | | | |
| Low Yield | 3.9 | 4.25 | 4.614 | 5.139 | 4.05 | 4.24 | 4.62 | 4.84 | 4.99 | 4.69 | 3.37 |
| Price at Low | N/A | N/A | N/A | 0 | N/A | N/A | 0 | N/A | N/A | N/A | N/A |
| Yield | | | | | | | | | | | |
| Avg/Med Yield | 3.968 | 4.305 | 4.64 | 5.175 | 4.1 | 4.285 | 4.663 | 4.88 | 5.05 | 4.74 | 3.47 |
| Price at | N/A | N/A | N/A | N/A | N/A | N/A | N/A | N/A | N/A | N/A | N/A |
| Avg/Med Yield | | | | | | | | | | | |
| High Yield | 3.99 | 4.33 | 4.66 | 5.19 | 4.12 | 4.3 | 4.69 | 4.9 | 5.07 | 4.76 | 3.52 |
| Price at High | 99.8 | 99.9 | 99.8 | 98.6 | 99.8 | 99.9 | 99.9 | 104 | 99.5 | 100 | 99.8 |
| Yield | | | | | | | | | | | |
| Allocation % | 74.43 | 45.57 | 14.06 | 76.13 | 50 | 4 | 78 | 12 | 100 | 1 | 17 |
| at High Rate | | | | | | | | | | | |
| Original Issue | N/A | N/A | N/A | 02/15/01 | N/A | N/A | N/A | 11/15/00 | N/A | 01/31/01 | 01/15/01 |
| Date | | | | | | | | | | | |
| Interest Rate | 3.875 | 4.25 | 4.625 | 5 | 4 | 4.25 | 4.625 | 5.75 | 5 | 4.75 | 3.5 |
| 1st Int. | 12/31/01 | 11/30/01 | 11/15/01 | 8/15/01 | 10/31/01 | 9/30/01 | 8/31/01 | 5/15/01 | 8/15/01 | 7/31/01 | 7/15/01 |
| Payment Date | | | | | | | | | | | |
| Series | R-2003 | Q-2003 | E-2006 | B-2011 | P-2003 | N-2003 | M-2003 | F-2005 | B-2011 | L-2003 | A-2011 |
| Standard | 19.375 | 21.25 | 23.125 | 25 | 20 | 21.25 | 23.125 | 28.75 | 25 | 23.75 | N/A |
| Interest | | | | | | | | | | | |
| Payment | | | | | | | | | | | |

July-Dec. 2000

| CUSIP | 9128276Q0 | 9128276P2 | 9128276N7 | 9128276J6 | 9128273L4 | 9128276L1 | 9128276K3 | 9128276D9 | 9128276J6 | 9128276H0 | 9128275W8 |
|---|---|---|---|---|---|---|---|---|---|---|---|
| Security | 2-YR | 2-YR | 5-YR | 9-YR 9- MTH | 2-YR | 2-YR | 2-YR | 4-YR 9- MTH | 10-YR | 2-YR | 9-YR 6- MTH |
| Description | | | | | | | | | | | |
| Announce | 12/20/00 | 11/22/00 | 11/1/00 | 11/1/00 | 10/18/00 | 9/20/00 | 8/16/00 | 8/2/00 | 8/2/00 | 7/19/00 | 7/5/00 |
| Date | | | | | | | | | | | |
| Auction Date | 12/27/00 | 11/29/00 | 11/7/00 | 11/8/00 | 10/25/00 | 9/27/00 | 8/23/00 | 8/8/00 | 8/9/00 | 7/26/00 | 7/12/00 |
| Issue Date | 1/2/01 | 11/30/00 | 11/15/00 | 11/15/00 | 10/31/00 | 10/2/00 | 8/31/00 | 8/15/00 | 8/15/00 | 7/31/00 | 7/17/00 |
| Maturity Date | 12/31/02 | 11/30/02 | 11/15/05 | 8/15/10 | 10/31/02 | 9/30/02 | 8/31/02 | 5/15/05 | 8/15/10 | 7/31/02 | 1/15/10 |
| Offering | 10 | 10 | 12 | 8 | 10 | 10 | 10 | 10 | 10 | 10 | 5 |
| Amount | | | | | | | | | | | |
| Total Amount | 29927574 | 36473573 | 24635175 | 23104704 | 31653935 | 34514975 | 31978514 | 33785687 | 21811212 | 31358358 | 11741020 |
| Tendered | | | | | | | | | | | |
| Total Amount | 14833574 | 15047553 | 15804415 | 10075194 | 14839335 | 15184475 | 15037514 | 13189107 | 12356702 | 15037258 | 5001620 |
| Accepted | | | | | | | | | | | |
| Low Yield | 5.06 | 5.665 | 5.79 | 5.8 | 5.795 | 5.97 | 6.14 | 5.99 | 5.75 | 6.21 | 3.88 |
| Price at Low | N/A | N/A | N/A | N/A | N/A | N/A | N/A | N/A | N/A | N/A | N/A |
| Yield | | | | | | | | | | | |
| Avg/Med Yield | 5.11 | 5.689 | 5.83 | 5.845 | 5.83 | 5.995 | 6.185 | 6.049 | 5.8 | 6.265 | 3.997 |
| Price at | N/A | N/A | N/A | N/A | N/A | N/A | N/A | N/A | N/A | N/A | N/A |
| Avg/Med Yield | | | | | | | | | | | |
| High Yield | 5.13 | 5.7 | 5.87 | 5.87 | 5.85 | 6 | 6.2 | 6.06 | 5.84 | 6.28 | 4.03 |
| Price at High | 100 | 99.9 | 99.5 | 99.1 | 99.8 | 100 | 99.9 | 103 | 99.3 | 99.9 | 104 |
| Yield | | | | | | | | | | | |
| Allocation % | 47 | 98 | 12 | 30 | 98 | 91 | 37 | 78 | 77 | 58 | 52 |
| at High Rate | | | | | | | | | | | |
| Original Issue | 01/02/01 | N/A | N/A | 08/15/00 | 10/31/97 | N/A | N/A | 05/15/00 | N/A | N/A | 01/18/00 |
| Date | | | | | | | | | | | |
| Interest Rate | 5.125 | 5.625 | 5.75 | 5.75 | 5.75 | 6 | 6.125 | 6.75 | 5.75 | 6.25 | 4.25 |
| 1st Int. | 6/30/01 | 5/31/01 | 5/15/01 | 2/15/01 | 4/30/01 | 3/31/01 | 2/28/01 | 11/15/00 | 2/15/01 | 1/31/01 | 1/15/01 |
| Payment Date | | | | | | | | | | | |
| Series | AD-2002 | AC-2002 | F-2005 | C-2010 | N-2002 | Z-2002 | Y-2002 | E-2005 | C-2010 | X-2002 | A-2010 |
| Standard | 25.625 | 28.125 | 28.75 | 28.75 | 28.75 | 30 | 30.625 | 33.75 | 28.75 | 31.25 | N/A |
| Interest | | | | | | | | | | | |
| Payment | | | | | | | | | | | |

Jan.-June 2000

| CUSIP | 9128276F4 | 9128276E7 | 9128276D9 | 9128275Z1 | 9128276C1 | 9128276B3 | 9128276A5 | 9128275S7 | 9128275Z1 | 9128275X6 | 9128275W8 |
|---|---|---|---|---|---|---|---|---|---|---|---|
| Security | 2-YR | 2-YR | 5-YR | 9-YR 9- MTH | 2-YR | 2-YR | 2-YR | 4-YR 9- MTH | 10-YR | 2-YR | 10-YR |
| Description | | | | | | | | | | | |
| Announce | 6/21/00 | 5/17/00 | 5/3/00 | 5/3/00 | 4/19/00 | 3/22/00 | 2/16/00 | 2/2/00 | 2/2/00 | 1/19/00 | 1/5/00 |
| Date | | | | | | | | | | | |
| Auction Date | 6/28/00 | 5/24/00 | 5/9/00 | 5/10/00 | 4/26/00 | 3/29/00 | 2/23/00 | 2/8/00 | 2/9/00 | 1/26/00 | 1/12/00 |
| Issue Date | 6/30/00 | 5/31/00 | 5/15/00 | 5/15/00 | 5/1/00 | 3/31/00 | 2/29/00 | 2/15/00 | 2/15/00 | 1/31/00 | 1/18/00 |
| Maturity Date | 6/30/02 | 5/31/02 | 5/15/05 | 2/15/10 | 4/30/02 | 3/31/02 | 2/28/02 | 11/15/04 | 2/15/10 | 1/31/02 | 1/15/10 |
| Offering | 10 | 10 | 12 | 8 | 12 | 12 | 12 | 12 | 10 | 14 | 6 |
| Amount | | | | | | | | | | | |
| Total Amount | 31326386 | 30049011 | 27183197 | 24010987 | 33051728 | 36049243 | 36492496 | 25052043 | 16782373 | 33731087 | 18740421 |
| Tendered | | | | | | | | | | | |
| Total Amount | 14310797 | 14838111 | 15458197 | 11075987 | 17371508 | 17219611 | 16527931 | 14230043 | 12270123 | 19346847 | 6316921 |
| Accepted | | | | | | | | | | | |
| Low Yield | 6.4 | 6.7 | 6.7 | 6.4 | 6.4 | 6.5 | 6.5 | 6.7 | 6.4 | 6.4 | 4.2 |
| Price at Low | N/A | N/A | N/A | N/A | N/A | N/A | N/A | N/A | N/A | N/A | N/A |
| Yield | | | | | | | | | | | |
| Avg/Med Yield | 6.47 | 6.72 | 6.76 | 6.45 | 6.46 | 6.55 | 6.57 | 6.71 | 6.47 | 6.42 | 4.3 |
| Price at | N/A | N/A | N/A | N/A | N/A | N/A | N/A | N/A | N/A | N/A | N/A |
| Avg/Med Yield | | | | | | | | | | | |
| High Yield | 6.483 | 6.749 | 6.789 | 6.475 | 6.484 | 6.58 | 6.59 | 6.741 | 6.54 | 6.434 | 4.338 |
| Price at High | 99.8 | 99.772 | 99.837 | 100.15 | 99.798 | 99.852 | 99.834 | 96.505 | 99.71 | 99.891 | 99.298 |
| Yield | | | | | | | | | | | |
| Allocation % | 67 | 70 | 22 | 26 | 62 | 33 | 18 | 98 | 49 | 28 | 30 |
| at High Rate | | | | | | | | | | | |
| Original Issue | N/A | N/A | N/A | 02/15/00 | N/A | N/A | N/A | N/A | 11/15/99 | N/A | N/A |
| Date | | | | | | | | | | | |
| Interest Rate | 6.375 | 6.625 | 6.75 | 6.5 | 6.375 | 6.5 | 6.5 | 5.875 | 6.5 | 6.375 | 4.25 |
| 1st Int. | 12/31/00 | 11/30/00 | 11/15/00 | 8/15/00 | 10/31/00 | 9/30/00 | 8/31/00 | 5/15/00 | 8/15/00 | 7/31/00 | 7/15/00 |
| Payment Date | | | | | | | | | | | |
| Series | W-2002 | V-2002 | E-2005 | B-2010 | U-2002 | T-2002 | S-2002 | H-2004 | B-2010 | R-2002 | A-2010 |
| Standard | 31.875 | 33.125 | 33.75 | 32.5 | 31.875 | 32.5 | 32.5 | 29.375 | 32.5 | 31.875 | N/A |
| Interest | | | | | | | | | | | |
| Payment | | | | | | | | | | | |

July-Dec. 1999

| CUSIP | 9128272E1 | 9128272C5 | 9128275S7 | 9128275N8 | 9128275R9 | 9128275Q1 | 9128275P3 | 9128275M0 | 9128275N8 | 9128275L2 |
|---|---|---|---|---|---|---|---|---|---|---|
| Security | 2-YR | 2-YR | 5-YR | 9-YR 9- MTH | 2-YR | 2-YR | 2-YR | 5-YR | 10-YR | 2-YR |
| Description | | | | | | | | | | |
| Announce | 12/15/99 | 11/17/99 | 11/3/99 | 11/3/99 | 10/20/99 | 9/22/99 | 8/18/99 | 8/4/99 | 8/4/99 | 7/21/99 |
| Date | | | | | | | | | | |
| Auction Date | 12/22/99 | 11/23/99 | 11/9/99 | 11/10/99 | 10/27/99 | 9/29/99 | 8/25/99 | 8/10/99 | 8/11/99 | 7/28/99 |
| Issue Date | 12/31/99 | 11/30/99 | 11/15/99 | 11/15/99 | 11/1/99 | 11/1/99 | 8/31/99 | 8/16/99 | 8/16/99 | 8/2/99 |
| Maturity Date | 12/31/01 | 11/30/01 | 11/15/04 | 8/15/09 | 10/31/01 | 9/30/01 | 8/31/01 | 8/15/04 | 8/15/09 | 7/31/01 |
| Offering | 15 | 15 | 15 | 10 | 15 | 15 | 15 | 15 | 12 | 15 |
| Amount | | | | | | | | | | |
| Total Amount | 33634006 | 41330776 | 31160228 | 27494213 | 44526986 | 35304183 | 33094922 | 30787673 | 27571198 | 37701473 |
| Tendered | | | | | | | | | | |
| Total Amount | 17176006 | 19445775 | 18390728 | 12639913 | 19187385 | 18782508 | 20106327 | 18070773 | 14746238 | 20510933 |
| Accepted | | | | | | | | | | |
| Low Yield | 6.1 | 5.9 | 5.8 | 5.9 | 5.9 | 5.6 | 5.5 | 5.9 | 6 | 5.5 |
| Price at Low | N/A | N/A | N/A | N/A | N/A | 0 | N/A | N/A | N/A | N/A |
| Yield | | | | | | | | | | |
| Avg/Med Yield | 6.21 | 5.94 | 5.87 | 5.99 | 5.92 | 5.65 | 5.53 | 5.99 | 6.07 | 5.52 |
| Price at | N/A | N/A | N/A | N/A | N/A | N/A | N/A | N/A | N/A | N/A |
| Avg/Med Yield | | | | | | | | | | |
| High Yield | 6.233 | 5.946 | 5.888 | 6.007 | 6.007 | 5.665 | 5.665 | 6.014 | 6.085 | 5.544 |
| Price at High | 99.8 | 99.868 | 99.868 | 99.927 | 99.888 | 99.925 | 99.893 | 99.94 | 99.37 | 99.917 |
| Yield | | | | | | | | | | |
| Allocation % | 19 | 34 | 90 | 8 | 40 | 58 | 54 | 71 | 58 | 1 |
| at High Rate | | | | | | | | | | |
| Original Issue | 12/31/96 | 12/02/96 | N/A | 08/16/99 | N/A | N/A | N/A | N/A | N/A | N/A |
| Date | | | | | | | | | | |
| Interest Rate | 6.125 | 5.875 | 5.875 | 6 | 5.875 | 5.625 | 5.5 | 6 | 6 | 5.5 |
| 1st Int. | 6/30/00 | 5/31/00 | 5/15/00 | 2/15/00 | 4/30/00 | 3/31/00 | 2/29/00 | 2/15/00 | 2/15/00 | 1/31/00 |
| Payment Date | | | | | | | | | | |
| Series | R-2001 | Q-2001 | H-2004 | H-2004 | AE-2001 | AD-2001 | AC-2001 | AC-2001 | C-2009 | AB-2001 |
| Standard | 30.625 | 29.375 | 29.375 | 30 | 29.375 | 28.125 | 27.5 | 30 | 30 | 27.5 |
| Interest | | | | | | | | | | |
| Payment | | | | | | | | | | |

Jan.-June 1999

| CUSIP | 9128274Y5 | 9128275J7 | 9128275H1 | 9128275F5 | 9128275G3 | 9128275E8 | 9128275D0 | 9128275C2 | 9128275A6 | 9128274V1 | 9128274Z2 |
|---|---|---|---|---|---|---|---|---|---|---|---|
| Security | 9-YR 6- MTH | 2-YR | 2-YR | 5-YR | 10-YR | 2-YR | 2-YR | 2-YR | 5-YR | 9-YR 9- MTH | 2-YR |
| Description | | | | | | | | | | | |
| Announce | 6/30/99 | 6/16/99 | 5/19/99 | 5/5/99 | 5/5/99 | 4/21/99 | 3/17/99 | 2/17/99 | 2/3/99 | 2/3/99 | 1/20/99 |
| Date | | | | | | | | | | | |
| Auction Date | 7/7/99 | 6/23/99 | 5/26/99 | 5/11/99 | 5/12/99 | 4/28/99 | 3/24/99 | 2/24/99 | 2/9/99 | 2/10/99 | 1/27/99 |
| Issue Date | 7/15/99 | 6/30/99 | 6/1/99 | 5/17/99 | 5/17/99 | 4/30/99 | 3/31/99 | 3/1/99 | 2/16/99 | 2/16/99 | 2/1/99 |
| Maturity Date | 1/15/09 | 6/30/01 | 5/31/01 | 5/15/04 | 5/15/09 | 4/30/01 | 3/31/01 | 2/28/01 | 2/15/04 | 11/15/08 | 1/31/01 |
| Offering | 7 | 15 | 15 | 15 | 12 | 15 | 15 | 15 | 15 | 10 | 15 |
| Amount | | | | | | | | | | | |
| Total Amount | 15096392 | 29693469 | 35123892 | 29987293 | 22280659 | 40875026 | 39664052 | 31961498 | 30243315 | 22043514 | 36636724 |
| Tendered | | | | | | | | | | | |
| Total Amount | 7368472 | 18985769 | 19869692 | 18912293 | 14798359 | 21027026 | 21587982 | 19575998 | 17815315 | 11592934 | 19772324 |
| Accepted | | | | | | | | | | | |
| Low Yield | 3.9 | 5.7 | 5.2 | 5.3 | 5.4 | 4.9 | 4.9 | 4.9 | 4.7 | 4.8 | 4.5 |
| Price at Low | N/A | N/A | N/A | N/A | N/A | N/A | 0 | N/A | N/A | N/A | N/A |
| Yield | | | | | | | | | | | |
| Avg/Med Yield | 4 | 5.73 | 5.3 | 5.35 | 5.47 | 5 | 4.97 | 4.99 | 4.75 | 4.88 | 4.54 |
| Price at | N/A | N/A | N/A | N/A | N/A | N/A | N/A | N/A | N/A | N/A | N/A |
| Avg/Med Yield | | | | | | | | | | | |
| High Yield | 4.04 | 5.754 | 5.315 | 5.367 | 5.51 | 5.017 | 4.995 | 5.009 | 4.767 | 4.913 | 4.575 |
| Price at High | 100.03 | 99.993 | 99.878 | 99.493 | 99.923 | 99.968 | 99.774 | 99.983 | 99.925 | 98.735 | 99.858 |
| Yield | | | | | | | | | | | |
| Allocation % | 88 | 72 | 20 | 75 | 59 | 45 | 20 | 54 | 14 | 11 | 42 |
| at High Rate | | | | | | | | | | | |
| Original Issue | 01/15/99 | N/A | N/A | N/A | N/A | N/A | N/A | N/A | N/A | 11/16/98 | N/A |
| Date | | | | | | | | | | | |
| Interest Rate | 3.875 | 5.75 | 5.25 | 5.25 | 5.5 | 5 | 4.875 | 5 | 4.75 | 4.75 | 4.5 |
| 1st Int. | 1/15/00 | 12/31/99 | 11/30/99 | 11/15/99 | 11/15/99 | 10/31/99 | 9/30/99 | 8/31/99 | 8/15/99 | 5/15/99 | 7/31/99 |
| Payment Date | | | | | | | | | | | |
| Series | A-2009 | Z-2001 | Y-2001 | F-2004 | B-2009 | X-2001 | W-2001 | V-2001 | E-2004 | D-2008 | U-2001 |
| Standard | N/A | 28.75 | 26.25 | 26.25 | 27.5 | 25 | 24.375 | 25 | N/A | 23.75 | 22.5 |
| Interest | | | | | | | | | | | |
| Payment | | | | | | | | | | | |

Sept.-Dec. 1998

| CUSIP | 9128274Y5 | 9128274X7 | 9128274W9 | 9128274V1 | 9128274U3 | 9128274T6 | 9128273T7 |
|---|---|---|---|---|---|---|---|
| Security Description | 10-YR | 2-YR | 2-YR | 10-YR | 5-YR | 2-YR | 9-YR 3-MTH |
| Announce Date | 12/30/98 | 12/23/98 | 11/18/98 | 10/28/98 | 10/28/98 | 10/21/98 | 9/29/98 |
| Auction Date | 1/6/99 | 12/29/98 | 11/24/98 | 11/4/98 | 11/3/98 | 10/28/98 | 10/7/98 |
| Issue Date | 1/15/99 | 12/31/98 | 11/30/98 | 11/16/98 | 11/16/98 | 11/2/98 | 10/15/98 |
| Maturity Date | 1/15/09 | 12/31/00 | 11/30/00 | 11/15/08 | 11/15/03 | 10/31/00 | 1/15/08 |
| Offering Amount | 8 | 15 | 16 | 12 | 16 | 16 | 8 |
| Total Amount Tendered | 25476152 | 42976651 | 38788545 | 19741208 | 31398418 | 36111960 | 15744658 |
| Total Amount Accepted | 8530979 | 19466121 | 20146545 | 13485708 | 18619933 | 20514660 | 8400538 |
| Low Yield | 3.9 | 4.7 | 4.5 | 4.6 | 4.3 | 3.9 | 3.3 |
| Price at Low Yield | N/A | N/A | N/A | N/A | N/A | N/A | 0 |
| Avg/Med Yield | 3.89 | 4.67 | 4.6 | 4.76 | 4.3 | 4 | 3.56 |
| Price at Avg/Med Yield | N/A | N/A | N/A | N/A | N/A | N/A | 0 |
| High Yield | 3.898 | 4.69 | 4.629 | 4.825 | 4.34 | 4.025 | 3.65 |
| Price at High Yield | 99.811 | 99.877 | 99.992 | 99.41 | 99.599 | 99.952 | 100.87 |
| Allocation % at High | 100 | 97 | 60 | 82 | 31 | 69 | 88 |
| Rate | | | | | | | |
| Original Issue Date | N/A | N/A | N/A | N/A | N/A | N/A | 01/15/98 |
| Interest Rate | 3.875 | 4.625 | 4.625 | 4.75 | 4.25 | 4 | 3.625 |
| 1st Int. Payment Date | 7/15/99 | 6/30/99 | 5/31/99 | 5/15/99 | 5/15/99 | 4/30/99 | 1/15/99 |
| Series | A-2009 | AL-2000 | AK-2000 | D-2008 | K-2003 | AJ-2000 | A-2008 |
| Standard Interest | N/A | 23.125 | 23.125 | 23.75 | 21.25 | 20 | N/A |
| Payment | | | | | | | |

APPENDIX 2:
Statistical Results
Short Coupon Trading
2-Year Sector
The REG Procedure
Model: MODEL1
Dependent Variable: SHORT Coupons
Analysis of Variance

| | | Sum of | Mean | | |
|---|---|---|---|---|---|
| Source | DF | Squares | Square | F Value | Pr > F |
| Model | 1 | 7522801528 | 7522801528 | 15.97 | 0.0002 |
| Error | 67 | 31565906251 | 471132929 | | |
| Corrected Total | 68 | 39088707779 | | | |

| | | | |
|---|---|---|---|
| Root MSE | 21706 | R-Square | 0.1925 |
| Dependent Mean | 126689 | Adj R-Sq | 0.1804 |
| Coeff Var | 17.13303 | | |

Parameter Estimates

| | | | Parameter | | | |
|---|---|---|---|---|---|---|
| Variable | Label | DF | Estimate | Standard Error | t Value | Pr > \|t\| |
| Intercept | Intercept | 1 | 120952 | 2981.49301 | 40.57 | <.0001 |
| AUC2 | 2-Year Auction Week | 1 | 24741 | 6191.53524 | 4.00 | 0.0002 |

17:51 Tuesday, April 1, 2003 1
Auction Effects on Cash Volume
Five-Year Sector
The REG Procedure
Model: MODEL2
Dependent Variable: BANK Range Coupons
Analysis of Variance

| | | Sum of | Mean | | |
|---|---|---|---|---|---|
| Source | DF | Squares | Square | F Value | Pr > F |
| Model | 1 | 3768601440 | 3768601440 | 7.99 | 0.0062 |
| Error | 67 | 31610112442 | 471792723 | | |
| Corrected Total | 68 | 35378713883 | | | |

| | | | |
|---|---|---|---|
| Root MSE | 21721 | R-Square | 0.1065 |
| Dependent Mean | 97023 | Adj R-Sq | 0.0932 |
| Coeff Var | 22.38720 | | |

Parameter Estimates

| | | | Parameter | | | |
|---|---|---|---|---|---|---|
| Variable | Label | DF | Estimate | Standard Error | t Value | Pr > \|t\| |
| Intercept | Intercept | 1 | 94958 | 2715.09876 | 34.97 | <.0001 |
| AUC5 | 5-Year Auction Week | 1 | 28506 | 10086 | 2.83 | 0.0062 |

What is claimed is:

1. A futures contract comprising a way to hedge exposure in when issued securities.

2. The futures contract of claim 1 further wherein the futures contract is cash settled.

3. The futures contract of claim 2 further wherein the futures contract settles for cash using the auction results as a reference rate.

4. The futures contract of claim 1 further including a trading unit.

5. The futures contract of claim 4 further wherein the trading unit is the notional value of a yet-to-be issued Treasury note.

6. The futures contract of claim 1 further including a delivery standard.

7. The futures contract of claim 6 further wherein the delivery standard is the auction yield result announced by the Federal Reserve Bank.

8. The futures contract of claim 1 further wherein the futures contract is a 2-year note futures contract.

9. The futures contract of claim 1 further wherein the futures contract is a 5-year note futures contract.

10. The futures contract of claim 1 further wherein the futures contract has a notional value of $1,000,000.

11. The futures contract of claim 1 further wherein the futures contract is quoted in yield terms.

12. The futures contract of claim 11 further wherein the yield quote is in basis points.

13. The futures contract of claim 11 further wherein the yield quote is in fractions of basis points.

14. The futures contract of claim 11 further wherein the yield quote is in basis points and fractions of basis points.

15. The futures contract of claim 11 further wherein the dollar value of one basis point for the contract equals $185.83.

16. The futures contract of claim 1 further wherein the futures contract is centered at a 6% market rate.

17. The futures contract of claim 1 further wherein the futures contract is centered consistent with existing 2-year, 5-year, 10-year and bond contracts that trade on a price and cash delivery basis at the Board of Trade of the City of Chicago.

18. The futures contract of claim 1 further wherein twelve consecutive calendar months are available for listing.

19. The futures contract of claim 1 further including a last trading day.

20. The futures contract of claim 19 further wherein the last trading day is the day a Treasury note is auctioned.

21. The futures contract of claim 19 further wherein the last trading day is the day a Treasury note is auctioned, at the same time as the auction takes place.

22. The futures contract of claim 1 further wherein the trading will cease at the time auction bids are due at the New York Federal Reserve.

23. The futures contract of claim 1 further wherein in the event that the Treasury cancels an announced and scheduled auction, the constant maturity rate published by the Federal Reserve for the scheduled auction day shall serve as the settlement reference rate.

24. The futures contract of claim 1 further wherein in the event the Treasury postpones an auction within the delivery month, the last trading day will remain the actual auction day and the settlement price will remain the auction price.

25. The futures contract of claim 1 further wherein in the event the Treasury postpones an auction so that it falls outside the current (spot) delivery month but does not supplant another scheduled auction, the last trading day will remain the actual auction day and the auction results will remain will remain the settlement reference rate.

26. The futures contract of claim 1 further including a way to hedge exposure in the auction bidding process

27. A futures contract comprising a way to hedge exposure in the auction bidding process.

28. The futures contract of claim 27 further wherein the futures contract is cash settled.

29. The futures contract of claim 28 further wherein the futures contract settles for cash using the auction results as a reference rate.

30. The futures contract of claim 27 further including a trading unit.

31. The futures contract of claim 30 further wherein the trading unit is the notional value of a yet-to-be issued Treasury note.

32. The futures contract of claim 27 further including a delivery standard.

33. The futures contract of claim 33 further wherein the delivery standard is the auction yield result announced by the Federal Reserve Bank.

34. The futures contract of claim 27 further wherein the futures contract is a 2-year note futures contract.

35. The futures contract of claim 27 further wherein the futures contract is a 5-year note futures contract.

36. The futures contract of claim 27 further wherein the futures contract has a notional value of $1,000,000.

37. The futures contract of claim 27 further wherein the futures contract is quoted in yield terms.

38. The futures contract of claim 37 further wherein the yield quote is in basis points.

39. The futures contract of claim 37 further wherein the yield quote is in fractions of basis points.

40. The futures contract of claim 37 further wherein the yield quote is in basis points and fractions of basis points.

41. The futures contract of claim 37 further wherein the dollar value of one basis point for the contract equals $185.83.

42. The futures contract of claim 27 further wherein the futures contract is centered at a 6% market rate.

43. The futures contract of claim 27 further wherein the futures contract is centered consistent with existing 2-year, 5-year, 10-year and bond contracts that trade on a price and cash delivery basis at the Board of Trade of the City of Chicago.

44. The futures contract of claim 27 further wherein twelve consecutive calendar months are available for listing.

45. The futures contract of claim 27 further including a last trading day.

46. The futures contract of claim 45 further wherein the last trading day is the day a Treasury note is auctioned.

47. The futures contract of claim 45 further wherein the last trading day is the day a Treasury note is auctioned, at the same time as the auction takes place.

48. The futures contract of claim 27 further wherein the trading will cease at the time auction bids are due at the New York Federal Reserve.

49. The futures contract of claim 27 further wherein in the event that the Treasury cancels an announced and scheduled auction, the constant maturity rate published by the Federal Reserve for the scheduled auction day shall serve as the settlement reference rate.

50. The futures contract of claim 27 further wherein in the event the Treasury postpones an auction within the delivery month, the last trading day will remain the actual auction day and the settlement price will remain the auction price.

51. The futures contract of claim 27 further wherein in the event the Treasury postpones an auction so that it falls outside the current (spot) delivery month but does not supplant another scheduled auction, the last trading day will remain the actual auction day and the auction results will remain will remain the settlement reference rate.

52. The futures contract of claim 27 further including a way to hedge exposure in when issued securities.

53. A commodities market comprising a futures contract in when issued securities that settle for cash at the auction yield.

54. The commodities market of claim 53 further wherein the futures contract is cash settled.

55. The commodities market of claim 54 further wherein the futures contract settles for cash using the auction results as a reference rate.

56. The commodities market of claim 53 further wherein the futures contract includes a trading unit.

57. The commodities market of claim 56 further wherein the trading unit is the notional value of a yet-to-be issued Treasury note.

58. The commodities market of claim 53 further wherein the futures contract includes a delivery standard.

59. The commodities market of claim 58 further wherein the delivery standard is the auction yield result announced by the Federal Reserve Bank.

60. The commodities market of claim 53 further wherein the futures contract is a 2-year note futures contract.

61. The commodities market of claim 53 further wherein the futures contract is a 5-year note futures contract.

62. The commodities market of claim 53 further wherein the futures contract has a notional value of $1,000,000.

63. The commodities market of claim 53 further wherein the futures contract is quoted in yield terms.

64. The commodities market of claim 63 further wherein the yield quote is in basis points.

65. The commodities market of claim 63 further wherein the yield quote is in fractions of basis points.

66. The commodities market of claim 63 further wherein the yield quote is in basis points and fractions of basis points.

67. The commodities market of claim 63 further wherein the dollar value of one basis point for the contract equals $185.83.

68. The commodities market of claim 53 further wherein the futures contract is centered at a 6% market rate.

69. The commodities market of claim 53 further wherein the futures contract is centered consistent with existing 2-year, 5-year, 10-year and bond contracts that trade on a price and cash delivery basis at the Board of Trade of the City of Chicago.

70. The commodities market of claim 53 further wherein twelve consecutive calendar months are available for listing.

71. The commodities market of claim 53 further wherein the futures contract includes a last trading day.

72. The commodities market of claim 71 further wherein the last trading day is the day a Treasury note is auctioned.

73. The commodities market of claim 71 further wherein the last trading day is the day a Treasury note is auctioned, at the same time as the auction takes place.

74. The commodities market of claim 53 further wherein the trading in the futures contract will cease at the time auction bids are due at the New York Federal Reserve.

75. The commodities market of claim 53 further wherein in the event that the Treasury cancels an announced and scheduled auction, the constant maturity rate published by the Federal Reserve for the scheduled auction day shall serve as the settlement reference rate.

76. The commodities market of claim 53 further wherein in the event the Treasury postpones an auction within the delivery month, the last trading day will remain the actual auction day and the settlement price will remain the auction price.

77. The commodities market of claim 53 further wherein in the event the Treasury postpones an auction so that it falls outside the current (spot) delivery month but does not supplant another scheduled auction, the last trading day will remain the actual auction day and the auction results will remain will remain the settlement reference rate.

78. A futures contract comprising carrying positions through the auction bidding process to capture spreads that develop between cash when issued markets and auction results.

79. The futures contract of claim 78 further wherein the futures contract is cash settled.

80. The futures contract of claim 80 further wherein the futures contract settles for cash using the auction results as a reference rate.

81. The futures contract of claim 78 further including a trading unit.

82. The futures contract of claim 81 further wherein the trading unit is the notional value of a yet-to-be issued Treasury note.

83. The futures contract of claim 78 further including a delivery standard.

84. The futures contract of claim 83 further wherein the delivery standard is the auction yield result announced by the Federal Reserve Bank.

85. The futures contract of claim 78 further wherein the futures contract is a 2-year note futures contract.

86. The futures contract of claim 78 further wherein the futures contract is a 5-year note futures contract.

87. The futures contract of claim 78 further wherein the futures contract has a notional value of $1,000,000.

88. The futures contract of claim 78 further wherein the futures contract is quoted in yield terms.

89. The futures contract of claim 88 further wherein the yield quote is in basis points.

90. The futures contract of claim 88 further wherein the yield quote is in fractions of basis points.

91. The futures contract of claim 88 further wherein the yield quote is in basis points and fractions of basis points.

92. The futures contract of claim 88 further wherein the dollar value of one basis point for the contract equals $185.83.

93. The futures contract of claim 78 further wherein the futures contract is centered at a 6% market rate.

94. The futures contract of claim 78 further wherein the futures contract is centered consistent with existing 2-year, 5-year, 10-year and bond contracts that trade on a price and cash delivery basis at the Board of Trade of the City of Chicago.

95. The futures contract of claim 78 further wherein twelve consecutive calendar months are available for listing.

96. The futures contract of claim 78 further including a last trading day.

97. The futures contract of claim 96 further wherein the last trading day is the day a Treasury note is auctioned.

98. The futures contract of claim 96 further wherein the last trading day is the day a Treasury note is auctioned, at the same time as the auction takes place.

99. The futures contract of claim 78 further wherein the trading will cease at the time auction bids are due at the New York Federal Reserve.

100. The futures contract of claim 78 further wherein in the event that the Treasury cancels an announced and scheduled auction, the constant maturity rate published by the Federal Reserve for the scheduled auction day shall serve as the settlement reference rate.

101. The futures contract of claim 78 further wherein in the event the Treasury postpones an auction within the delivery month, the last trading day will remain the actual auction day and the settlement price will remain the auction price.

102. The futures contract of claim 78 further wherein in the event the Treasury postpones an auction so that it falls outside the current (spot) delivery month but does not supplant another scheduled auction, the last trading day will remain the actual auction day and the auction results will remain will remain the settlement reference rate.

103. The futures contract of claim 78 further including a way to hedge exposure in when issued securities.
